(19) United States
(12) Patent Application Publication
(10) Pub. No.: US 2023/0294586 A1
(43) Pub. Date: Sep. 21, 2023

(54) VEHICLE WITH LOAD RECEPTACLE

(71) Applicant: Fraunhofer-Gesellschaft zur Foerderung der Angewandten Forschung e.V., Muenchen (DE)

(72) Inventors: Jan BEHLING, Muenchen (DE); Mathias ROTGERI, Muenchen (DE); Jan Soeren EMMERICH, Muenchen (DE); Dirk HOENING, Muenchen (DE); Patrick KLOKOWSKI, Muenchen (DE); Christian HAMMERMEISTER, Muenchen (DE); Michael TEN HOMPEL, Muenchen (DE)

(73) Assignee: Fraunhofer-Gesellschaft zur Foerderung der Angewandten Forschung e.V., Muenchen (DE)

(21) Appl. No.: 18/021,049

(22) PCT Filed: Aug. 13, 2021
(86) PCT No.: PCT/EP2021/072573

§ 371 Date: Feb. 13, 2023

(30) Foreign Application Priority Data
Aug. 20, 2020 (DE) 10 2020 121 883.4

(51) Int. Cl. B60P 1/28; B65G 67/24

(52) U.S. Cl. CPC B60P 1/283; B65G 67/24

(57) ABSTRACT

In a vehicle with a cargo receiving portion for transportation of cargo and for transfer of the cargo onto a cargo take-up station, the cargo receiving portion is disposed on a chassis with running gear coupled with a drive unit and a vehicle control unit is provided. The cargo receiving portion is linked tiltably around a tilting axle on the chassis and is open or openable at one delivery rim at least. The tilting axle and the delivery rim are disposed relative to one another so that, in tilted position, the cargo can be transferred via the delivery rim onto the cargo take-up station, wherein, for transfer of the cargo onto the cargo take-up station, the cargo receiving portion is tilted around the tilting axle by a change of the vector of velocity of the vehicle and/or by a torque generated by a spring loading of the cargo receiving portion.

The invention relates to a vehicle with a cargo receiving portion for transportation of cargo and for transfer of the cargo onto a cargo take-up station, wherein the cargo receiving portion is disposed on a chassis with running gear, wherein the running gear is coupled with a drive unit and a vehicle control unit is provided.

In transport systems, especially in sorting systems, cargoes from at least one dispensing station are transported and sorted in at least one cargo take-up station. In a highly dynamic sorting system formed from individual vehicles and capable of high throughput, a high-throughput and thus fastest possible transfer of cargo from the vehicle to the cargo take-up station (terminal point) is necessary. For this purpose, ideally it should be possible, for cost reasons, for the cargo transfer to be triggered completely by the vehicle itself and to not require any actively driven elements at the cargo take-up stations, and even additional active elements on the vehicle that are needed only for the transfer should be avoided as much as possible for cost reasons.

In the prior art, a large number of transfer principles are known both for driverless transport vehicles and also from the field of conventional sorting technology. Driverless transport vehicles mostly have active load-receiving means (usually horizontally and/or partly vertically movable). These include roller tracks, belt conveyors, fork arms, lifting platforms, articulated robots, specific grippers, tilt trays and the like. Such driverless transport vehicles are therefore very complex.

Some driverless transport vehicles have passive platforms, from which a person or a stationary active technology removes something.

Two solutions are also known in which both the respective driverless transport vehicle and the cargo take-up station are passive. From DE 10 2008 039 764 B4, an apparatus is known for comb-like stripping of transport goods during the travel of the driverless transport vehicle through a station, wherein the cargo is retained at a static stop of the station. However, this procedure may lead to damage to the cargo at higher velocities.

From DE 10 2015 114 370 B4, a driverless transport system for a warehouse and picking installation is known, in which no collection of several transport goods delivered in succession is possible unless an active intervention takes place beforehand (removal by a person or transport away by means of active stations).

From CN 110 756 444 A, a logistics system and a logistics shipping method with a transport robot are known. From the not previously published document DE 10 2019 122 055 A1, a method for transfer of cargo from a cargo receiving portion of a vehicle to a cargo take-up station is known, wherein the vehicle is controlled by a vehicle control unit. Therein the vector of the velocity of the vehicle is changed immediately before or upon arrival at the cargo take-up station and the vehicle, before arrival at the cargo take-up station, is oriented by the vehicle control unit and/or by at least one guide device disposed in the region of the cargo take-up station in such a way that the trajectory of the cargo moving away from the cargo receiving portion due to the change of the velocity vector ends in a receiving region of the cargo take-up station.

The task of the invention is to create a solution having driverless vehicles in which the cargo transfer is triggered by the vehicle itself, without the need for actively driven elements at the cargo take-up station.

This task is accomplished in a vehicle of the type mentioned in the introduction by the fact that the cargo receiving portion is linked tiltably around a tilting axle on the chassis and is designed to be open or openable at one delivery rim at least, wherein the tilting axle and the delivery rim are disposed relative to one another in such a way that, in tilted position, the cargo can be transferred via the delivery rim onto the cargo take-up station, wherein, for transfer of the cargo onto the cargo take-up station, the cargo receiving portion is tilted around the tilting axle by a change of the vector of velocity of the vehicle and/or by a torque generated by a spring loading of the cargo receiving portion.

According to the invention, the transfer of the cargo from the vehicle to the cargo take-up station therefore takes place without additional elements by the fact that the cargo receiving portion is tilted around the tilting axle and the cargo slides due to the tilting movement from the cargo receiving portion onto the cargo take-up station. The tilting movement of the cargo receiving portion may be triggered either by braking or acceleration of the vehicle or by spring loading (compression springs, tension springs and/or torsion springs) or by a combination of both aforesaid mechanisms. When the vector of velocity of the vehicle is changed, the cargo can be moved in the direction of the cargo take-up station not only by the tilting movement of the cargo receiving portion but also additionally by its inertia.

In a preferred configuration, it is provided that the cargo receiving portion has an interlocking element, by means of which the cargo receiving portion can be interlocked with the chassis in untilted position and can be unlocked prior to load delivery. Due to this interlocking element, it is ensured that the tilting movement of the cargo receiving portion cannot be inadvertently triggered, e.g. during travel of the vehicle.

In this connection, it is provided according to a first configuration that the interlocking element can be unlocked by the vehicle control unit. When the vehicle is in the neighborhood of the cargo take-up station, the vehicle control unit then releases the interlocking element, so that the tilting movement can be triggered.

In a preferred configuration, this interlocking element is an electromagnet.

Alternatively, it may also be provided that the interlocking element is coupled with an unlocking element, which can be activated by mechanical contact with a trigger element disposed in the region of the cargo take-up station. This trigger element may be disposed on the cargo take-up station itself, for example, or in the bottom region, depending on the respective space conditions.

In a further configuration, it is provided that, for spring loading of the cargo receiving portion, at least one spring element is disposed between the cargo receiving portion and the chassis. This at least one spring element is preferably designed as a compression spring, tension spring or torsion spring; several spring elements may also be provided in combination. The spring elements are obviously disposed between the cargo receiving portion and the chassis in such a way that they are able to trigger the tilting movement of the cargo receiving portion according to their spring characteristic. In this configuration, the interlocking element is usually unlocked only just before the desired cargo delivery.

The preloading of the respective spring element may take place in different ways:

According to a first configuration, it is provided that the at least one spring element can be preloaded by a change of the vector of velocity of the vehicle.

According to a second configuration, it is provided that the vehicle has a motor, by means of which the at least one spring element can be preloaded.

According to a third configuration, it is provided that the at least one spring element can be preloaded by travel of the vehicle through a slide-type guide.

The invention is explained in more detail in the following by way of example on the basis of the drawing. Therein, respectively in schematic perspective view,

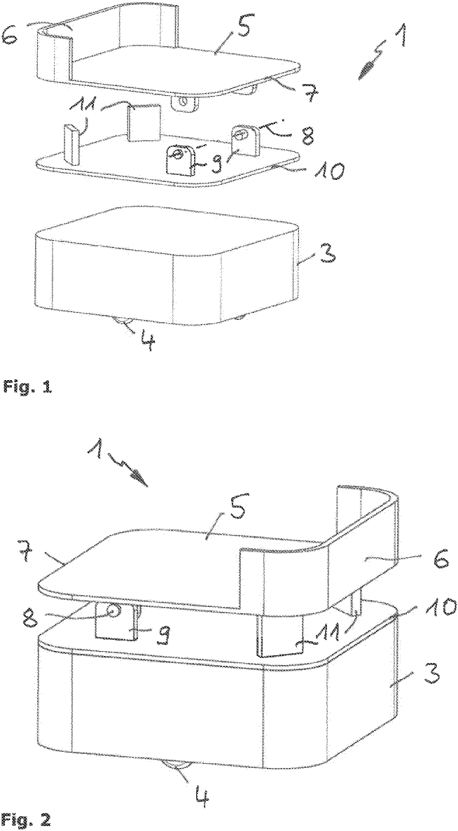

FIG. 1 shows an exploded diagram of a vehicle according to a first embodiment,

FIG. 2 shows the vehicle according to FIG. 1,

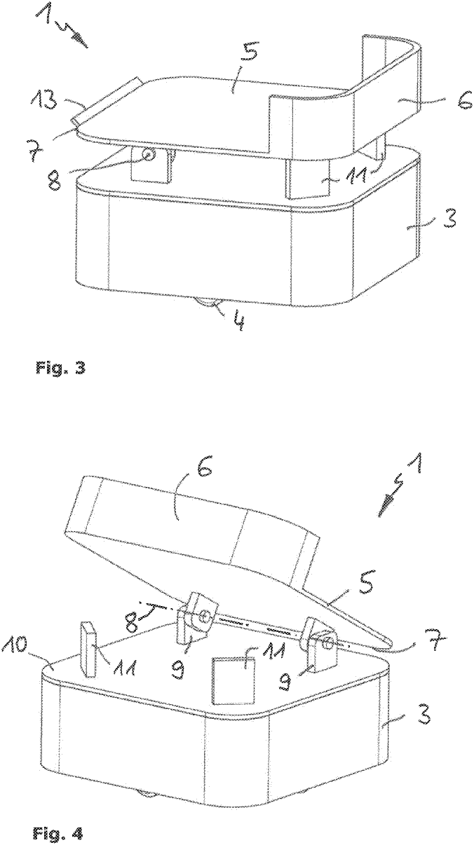

FIG. 3 shows a vehicle slightly modified compared with FIGS. 1 and 2,

FIG. 4 shows the vehicle according to FIGS. 1 and 2 with tilted cargo receiving portion,

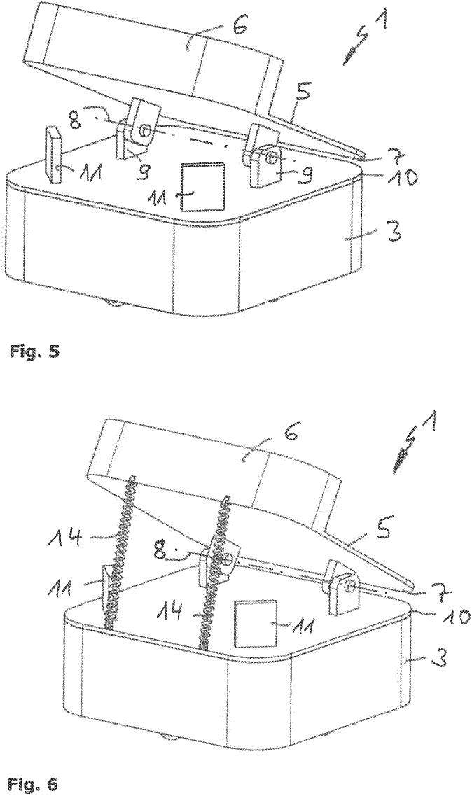

FIG. 5 shows the vehicle according to FIG. 4 with differently disposed tilting axle,

FIG. 6 shows the vehicle according to FIG. 4 with tension springs for resisting the tilting movement,

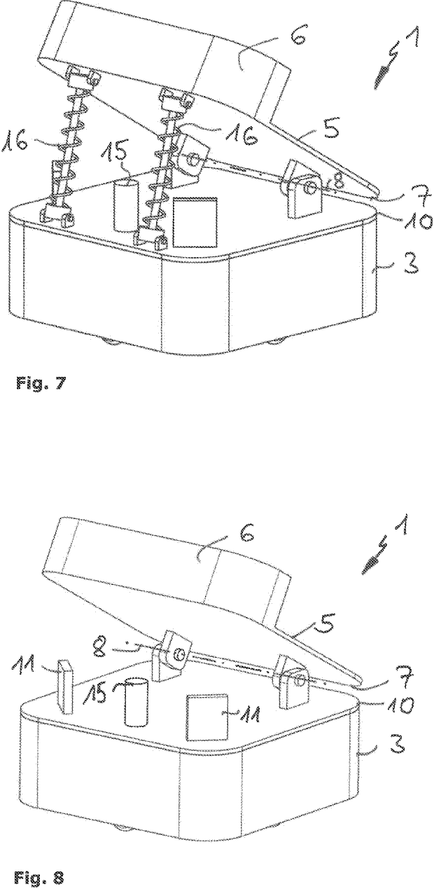

FIG. 7 shows the vehicle according to FIG. 4 with compression springs and an electromagnet,

FIG. 8 shows the vehicle according to FIG. 4 with an electromagnet,

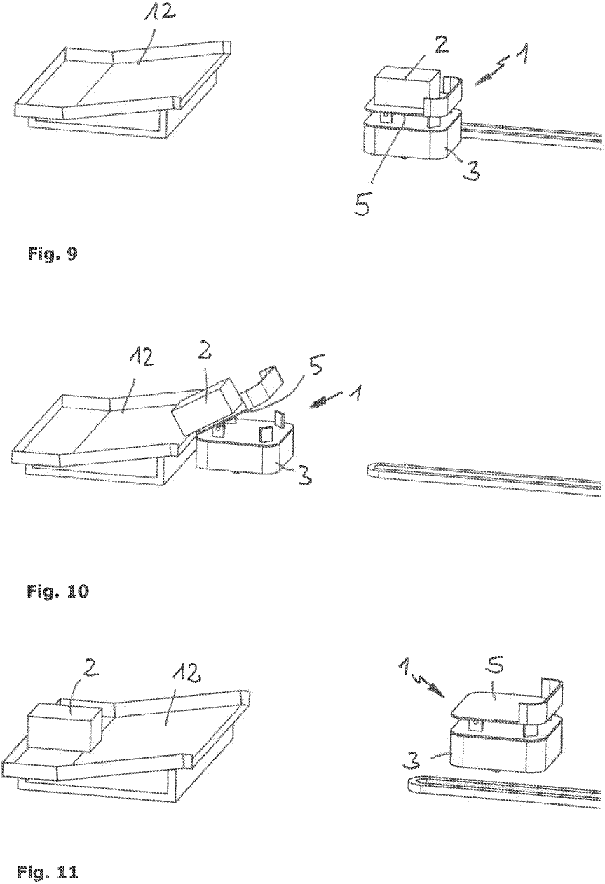

FIG. 9 shows the vehicle according to FIG. 1 during the approach to a cargo take-up station,

FIG. 10 shows the vehicle according to FIG. 9 after braking and triggering of the tilting movement,

FIG. 11 shows the vehicle according to FIG. 10 after cargo transfer,

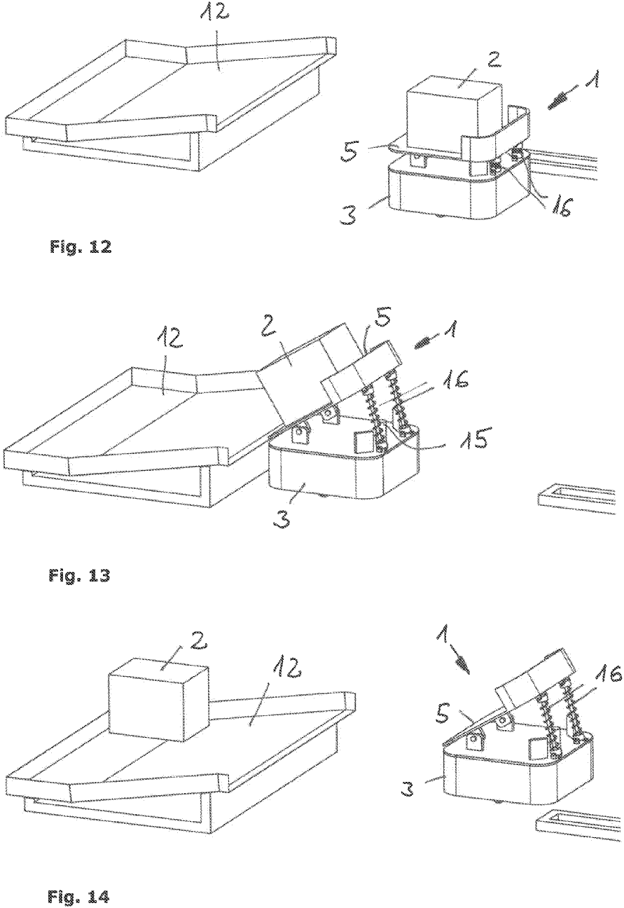

FIG. 12 shows the vehicle according to FIG. 7 before the cargo transfer,

FIG. 13 shows the vehicle according to FIG. 12 during the cargo transfer,

FIG. 14 shows the vehicle according to FIG. 12 after cargo transfer,

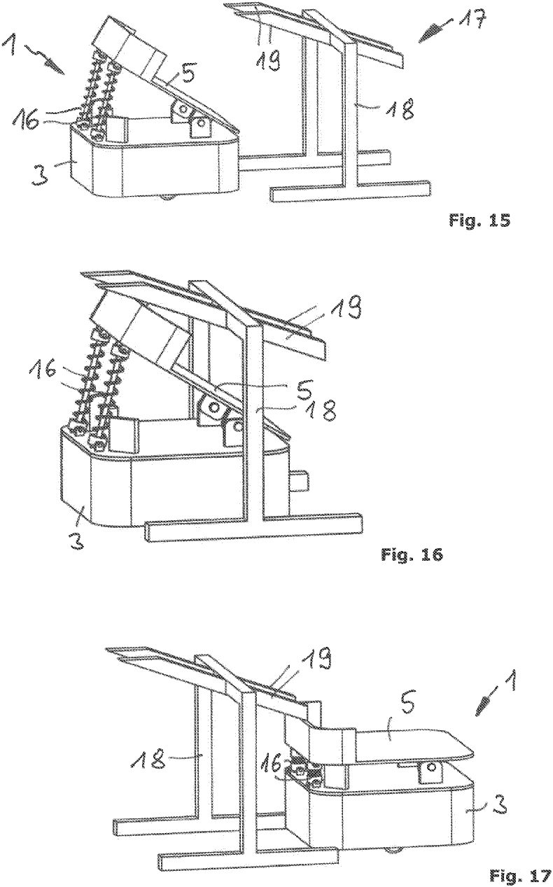

FIG. 15 shows the vehicle according to FIG. 14 before entry into a slide-type guide,

FIG. 16 shows the vehicle according to FIG. 15 during entry into a slide-type guide for preloading of the compression springs,

FIG. 17 shows the vehicle according to FIG. 16 at the end of passage through the slide-type guide,

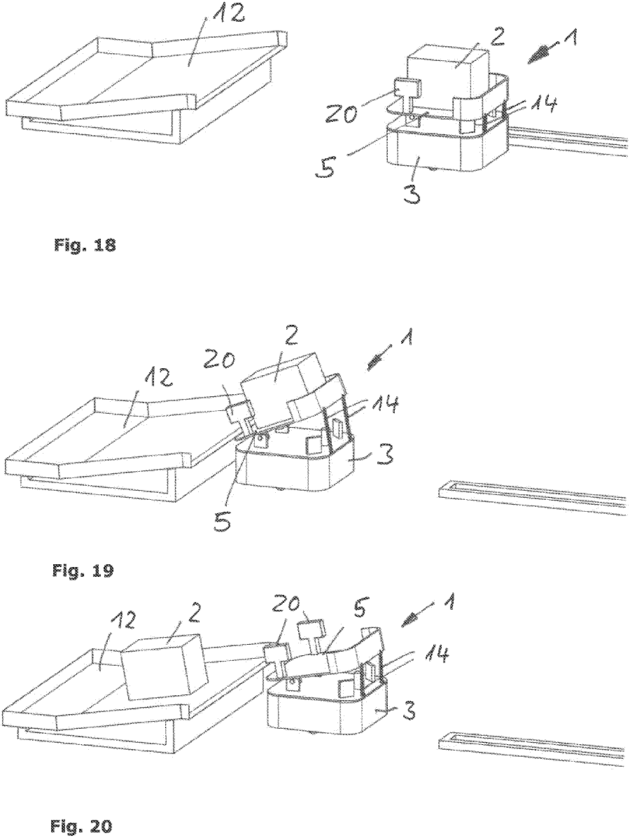

FIG. 18 shows a vehicle with additional weights and tension springs before the cargo transfer,

FIG. 19 shows the vehicle according to FIG. 18 during the cargo transfer,

FIG. 20 shows the vehicle according to FIG. 19 shortly after the cargo transfer and

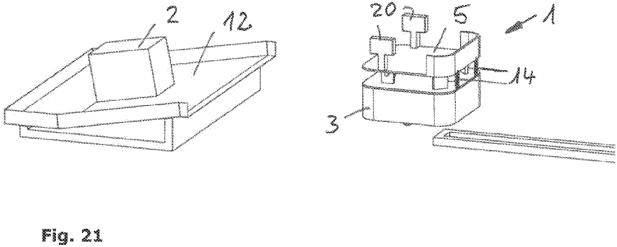

FIG. 21 shows the vehicle according to FIG. 20 after cargo transfer in home position imposed by the tension springs.

A vehicle according to the invention is generally denoted by 1 in the figures. This driverless vehicle 1 for transportation and for transfer or delivery of cargo 2 has a chassis generally denoted by 3 having running gear, of which running rollers or running wheels 4 are indicated. The running gear is coupled with a drive unit, not illustrated, disposed on the chassis 3, e.g. an electric motor, which is connected with a vehicle control unit, likewise not illustrated.

A flat cargo receiving portion 5 is provided on the upper side of the chassis 3 and has, at least in the rear region, in the illustrated exemplary embodiments, a closed side wall 6, which in plan view in the exemplary embodiments is of arch-like design, i.e. bounding the rear side and partly the sides of the cargo receiving portion 5. The side wall 6 may also be configured differently and does not have to be completely closed. The cargo receiving portion 5 is open or openable in the region of a front delivery rim 7. If it is designed to be openable, which is not illustrated schematically, it can be provided with, for example, a swivelable or vertically positionable rim boundary, which can be opened on demand by the vehicle control unit.

The cargo receiving portion 5 is disposed tiltably around a tilting axle 8 on the chassis 3. For this purpose, two tilting bearings 9 are disposed in the exemplary embodiment according to FIG. 1 on a baseplate 10, which on the upper side is joined with the chassis 3. In the exemplary embodiment, the two tilting bearings 9 and thus the tilting axle 8 are disposed in the front region of the vehicle 1 and the tilting axle 8 is disposed parallel to the front delivery rim 7. Two supports 11 for the cargo receiving portion 5 are provided on the baseplate 10 in the rear region, so that in resting position (FIG. 2) the cargo receiving portion 5 is usually aligned parallel to the baseplate 10.

When such a vehicle 1 according to FIGS. 1 and 2 for cargo transfer approaches a cargo take-up station 12 (FIG. 9), it is moved by the vehicle control unit with normal transport velocity at first.

For cargo transfer, the vector of velocity of the vehicle 1 in this exemplary embodiment (FIG. 10) is reduced by the vehicle control unit shortly before reaching the cargo take-up station 12, i.e. the vehicle is braked in this case. During this braking process, the cargo 2, possibly because of its inertia, already begins to slide forward on the cargo receiving portion 5, in addition to which the cargo receiving portion 5 is tilted around the tilting axle 8 due to the braking process, so that the vehicle 1 assumes the tilted position according to FIG. 10. In this position, the cargo 2 is delivered onto the cargo take-up station 12.

After cargo transfer onto the cargo take-up station 12, the vehicle 1 is moved in opposite direction by the vehicle control unit and now departs without cargo from the cargo take-up station 12 (FIG. 11). In the process, the cargo receiving portion 5 is swiveled by its own weight around the tilting axle 8 back into its original or resting position.

An embodiment of the vehicle 1, slightly modified compared with FIGS. 1 and 2, is illustrated in FIG. 3. This vehicle 1 according to FIG. 3 differs from the vehicle 1 according to FIGS. 1 and 2 in that an upwardly slanting load-securing edge 13, which prevents the cargo 2 from accidentally falling off during the travel of the vehicle 1, is provided on the front delivery rim 7 of the cargo receiving portion 5.

In FIG. 4, the vehicle according to FIGS. 1 and 2 is illustrated in tilted position of the cargo receiving portion 5, and in this exemplary embodiment the tilting axle 8 is disposed relatively far to the front. In contrast to this, FIG. 5 shows a configuration of a vehicle 1 in which the tilting axle 8 is disposed further to the rear than in the embodiment according to FIG. 4, i.e. centrally on the vehicle 1. The lever ratios can be constructively influenced by this different arrangement of the tilting axle 8 on the vehicle 1.

A vehicle 1 modified compared with FIGS. 1 and 2 is illustrated in FIG. 6, and in the rear region between the chassis 3 or the baseplate 10 and the cargo receiving portion 5 it has two tension springs 14. The tension springs 14 in the rear region of the vehicle 1 resist or prevent the tilting movement of the cargo receiving portion 5. Such a configuration of the vehicle 1 is provided to inhibit a too easy triggering of the tilting movement, especially during the travel of the vehicle 1, wherein the hold-down force can be adjusted by the tension springs 14 on the basis of the choice of the tension springs 14.

In FIG. 7, a vehicle 1 is illustrated that in contrast to the vehicle 1 according to FIGS. 1 and 2 has a cargo receiving portion 5 with an interlocking element, by means of which the cargo receiving portion 5 can be interlocked with the chassis 3 in untilted position and can be unlocked prior to load delivery. In the vehicle according to FIG. 7, this interlocking element is designed as an electromagnet 15, which is fastened on the baseplate 10 and holds the cargo receiving portion 5 securely on its underside and releases it when triggered by the vehicle control unit. The cargo receiving portion 5 consists at least in the region of contact with the electromagnet 15 of a magnetizable material or is equipped with a magnetic plate or the like. Preferably, the electromagnet 15 is a combination of a permanent magnet, which holds the cargo receiving portion 5 securely without applied voltage, and of an electromagnet, which is able to demagnetize the permanent magnet with applied voltage.

To permit cargo transfer or delivery from the cargo receiving portion 5, the electromagnet 15 is deactivated by the vehicle control unit prior to the cargo transfer.

Beyond this, the vehicle according to FIG. 7 has, in the rearward region between the chassis 3 and the cargo receiving portion 5, two compression springs 16, which tilt the cargo receiving portion 5 around the tilting axle 8 after release of the interlocking element, i.e. the deactivation of the electromagnet 15 in the exemplary embodiment according to FIG. 7.

In FIG. 8, a vehicle 1 is illustrated that differs from that according to FIG. 7 only in that the compression springs are omitted, but it is likewise provided with an electromagnet 15. This electromagnet 15 is deactivated by the vehicle control unit shortly before the load transfer, and so the cargo receiving portion 5 tilts due to inertia upon change of the velocity vector of the vehicle 1; after cargo delivery, the cargo receiving portion 5 tilts back into the resting position via its weight of the cargo receiving portion 5.

In FIGS. 12 to 14, the cargo transfer for a vehicle 1 with compression springs 16 according to FIG. 7 is illustrated.

In the stage of FIG. 12, the vehicle 1 with the cargo 2 is approaching the cargo take-up station 12. The interlocking element is still interlocked, i.e. in this situation the electromagnet 15 is still activated.

Shortly before reaching the cargo station 12, the interlocking element is deactivated by the vehicle control unit, i.e. in this case the electromagnet 15. The cargo receiving portion 5 is swiveled by the compression springs 16 around the tilting axle 8, whereby the cargo 2 arrives in the cargo take-up station 12. This tilting movement is assisted not only by the action of the compression springs 16 but additionally by the process of braking of the vehicle 1.

FIG. 14 shows the situation in which the cargo 2 has already been delivered onto the cargo take-up station 12 and the vehicle 1 is now departing from the cargo take-up station 12, while the cargo receiving portion 5 is still situated in tilted position.

In FIGS. 15 to 17, one way in which the vehicle 1 can be restored to normal traveling position with untilted cargo receiving portion 5 after cargo delivery (FIG. 14) is illustrated. For this purpose, it is provided that the compression springs 16 can be preloaded by travel of the vehicle 1 through a slide-type guide denoted in general with 17. The slide-type guide 17 is indicated schematically in FIGS. 15 to 17 and has an entrance gate 18 with, on the upper side, two downwardly slanting slide members 19. The width of the entrance gate 18 is such that the vehicle 1 is able to travel through the slide-type guide 17.

In FIG. 15, the vehicle 1 with cargo receiving portion 5 still tilted is situated in front of the slide-type guide 17, whereas in FIG. 16 it is already entering the slide-type guide 17. In the process, the cargo receiving portion 5, via the side wall 6, comes into contact with the slide members 19, which during further passage of the vehicle 1 press the cargo receiving portion 5 so far downward against the force of the compression springs 16 that the cargo receiving portion 5 bears on the supports 11. In this situation, the electromagnet 15 is activated by the vehicle control unit and holds the cargo receiving unit 5 in this position. Thereby the compression springs 16 are preloaded, so that the vehicle 1, after receiving a cargo 2, is again ready for cargo delivery by tilting of the cargo receiving portion 5.

In FIGS. 18 to 21, the cargo delivery is illustrated with a vehicle 1 that has two tension springs 14 in the rear region, as in the exemplary embodiment according to FIG. 6. In the front region of the cargo receiving portion 5, an additional weight 20 is respectively disposed on both sides on the cargo receiving portion 5. These additional weights 20 permit the tilting movement by changing the vector of velocity in conjunction with the position of the tilting axle 8 and the dimensioning of the tension springs 14.

In the position illustrated in FIG. 18, the vehicle 1 is approaching the cargo take-up station 12 without being tilted. In FIG. 19, the vehicle 1 is situated directly in front of the cargo take-up station 12, where it has been braked by the vehicle control unit, whereby the tilting movement of the cargo receiving portion 5 is triggered. At the same time, the optionally present electromagnet 15 has been deactivated by the vehicle control unit.

In the position illustrated in FIG. 20, the cargo 2 has been delivered onto the cargo take-up station 12 and the vehicle 1 is departing from the cargo take-up station 12, but still with the cargo receiving portion 5 situated in slightly tilted position.

Due to the action of the force of the tension springs 14, however, the cargo receiving portion 5 is tilted back into the resting position (FIG. 21) and is optionally interlocked by activation of the electromagnet 15.

Naturally the invention is not limited to the illustrated exemplary embodiments. Further configurations are possible without departing from the basic concepts. Thus, for triggering of the tilting movement, it is also possible to provide tension springs in the front region of the vehicle 1, between the chassis 3 and the cargo receiving portion 5, in order to initiate the tilting movement of the cargo receiving portion 5 with appropriate arrangement of the tilting axle 8. Alternatively, it is also possible to provide torsion springs, which are disposed in the region of the tilting axle 8.

List of reference symbols:

| | |
|---|---|
| 1 | Vehicle |
| 2 | Cargo |
| 3 | Chassis |
| 4 | Running wheels |
| 5 | Cargo receiving portion |
| 6 | Side wall |
| 7 | Delivery rim |
| 8 | Tilting axle |
| 9 | Tilting bearing |
| 10 | Baseplate |
| 11 | Support |
| 12 | Cargo take-up station |
| 13 | Load securing edge |
| 14 | Tension springs |
| 15 | Electromagnet |
| 16 | Compression springs |
| 17 | Slide-type guide |
| 18 | Entrance gate |
| 19 | Slide members |
| 20 | Additional weight |

1. A vehicle (1) with a cargo receiving portion (5) for transportation of cargo (2) and for transfer of the cargo (2) onto a cargo take-up station (12), wherein the cargo receiving portion (5) is disposed on a chassis (3) with running gear, wherein the running gear is coupled with a drive unit and a vehicle control unit is provided, wherein
the cargo receiving portion (5) is linked tiltably around the tilting axle (8) on the chassis (3) and is designed to be open or openable at one delivery rim (7) at least, wherein the tilting axle (8) and the delivery rim (7) are disposed relative to one another in such a way that, in tilted position, the cargo (2) can be transferred via the delivery rim (7) onto the cargo take-up station (12), wherein, for transfer of the cargo (2) onto the cargo take-up station (12), the cargo receiving portion (5) is tilted around the tilting axle (8) by a change of the vector of velocity of the vehicle (1) and/or by a torque generated by a spring loading of the cargo receiving portion (5).

2. The vehicle according to claim 1, wherein
the cargo receiving portion (5) has an interlocking element (15), by means of which the cargo receiving portion (5) can be interlocked with the chassis (3) in untilted position and can be unlocked prior to the load delivery.

3. The vehicle according to claim 2, wherein
the interlocking element (15) can be unlocked by the vehicle control unit.

4. The vehicle according to claim 3, wherein
the interlocking element is an electromagnet (15).

5. The vehicle according to claim 2, wherein
the interlocking element (15) is coupled with an unlocking element, which can be activated by mechanical contact with a trigger element disposed in the region of the cargo take-up station (12).

6. The vehicle according to claim 1, wherein,
for spring loading of the cargo receiving portion (5), at least one spring element (16) is disposed between the cargo receiving portion and the chassis.

7. The vehicle according to claim 6, wherein
the at least one spring element (16) is designed as a compression spring, tension spring or torsion spring.

8. The vehicle according to claim 7, wherein
the at least one spring element (16) can be preloaded by a change of the vector of velocity of the vehicle.

9. The vehicle according to claim 7, wherein
it has a motor, by means of which the at least one spring element (16) can be preloaded.

10. The vehicle according to claim 7, wherein
the at least one spring element (16) can be preloaded by travel of the vehicle (1) through a slide-type guide (17).
